(19) United States
(12) Patent Application Publication
(10) Pub. No.: US 2025/0184701 A1
(43) Pub. Date: Jun. 5, 2025

(54) SYSTEMS AND METHODS FOR NETWORK-BASED PROVISIONING OF COMBINED SECURITY SERVICES FOR SUBSCRIBERS

(71) Applicant: Verizon Patent and Licensing Inc., Basking Ridge, NJ (US)

(72) Inventor: Jude M. MUNN, Bay Point, CA (US)

(73) Assignee: Verizon Patent and Licensing Inc., Basking Ridge, NJ (US)

(21) Appl. No.: 18/525,009

(22) Filed: Nov. 30, 2023

(51) Int. Cl. H04W 4/50; H04W 72/543

(52) U.S. Cl. CPC H04W 4/50; H04W 72/543

(57) ABSTRACT

A device may receive control traffic that includes a plurality of provisioning events associated with a network, and may identify provisioning events, of the plurality of provisioning events, that are associated with a service. The device may calculate a quantity of the provisioning events that are associated with the service, and may determine whether the quantity of the provisioning events satisfies a quantity threshold. The device may provide the quantity of the provisioning events to network devices that provide the service to subscribers based on the quantity of the provisioning events failing to satisfy the quantity threshold, or may calculate a remaining quantity of the provisioning events that are associated with the service based on the quantity of the provisioning events satisfying the quantity threshold.

### BACKGROUND

A provisioning system may provision a network and network elements for services, such as security as a service (SaaS), a threat protection service, a firewall service, and/or the like. The services may be provided to subscribers associated with user equipments (UEs).

### BRIEF DESCRIPTION OF THE DRAWINGS

FIGS. 1A-1G are diagrams of an example associated with network-based provisioning of combined security services for subscribers.

FIG. 2 is a diagram of an example environment in which systems and/or methods described herein may be implemented.

FIG. 3 is a diagram of example components of one or more devices of FIG. 2.

FIG. 4 is a flowchart of an example process for network-based provisioning of combined security services for subscribers.

### DETAILED DESCRIPTION OF EXAMPLE EMBODIMENTS

The following detailed description of example implementations refers to the accompanying drawings. The same reference numbers in different drawings may identify the same or similar elements.

SaaS, a threat protection service, and/or a firewall service for subscribers are provided based on a network function (e.g., a user plane function (UPF)) of fifth generation (5G) core network communicating with a data network (e.g., the Internet), via a network device. The provisioning system may utilize a proxy unified data management (UDM) device to provision (e.g., via provisioning events) the UPF and the network device to provide the SaaS, the threat protection service, and/or the firewall service (e.g., combined security services) for multiple subscribers. However, the proxy UDM may only handle a particular quantity of provisioning events associated with provisioning combined security services for subscribers. Therefore, as a quantity of subscribers for the combined security services increases, the proxy UDM may be unable to handle additional provisioning events associated with provisioning the combined security services for additional subscribers. Thus, current techniques for provisioning combined security services for subscribers of a network consume computing resources (e.g., processing resources, memory resources, communication resources, and/or the like), networking resources, and/or other resources associated with failing to provision combined security services for subscribers when the quantity of provisioning events exceeds the particular quantity, handling network threats associated with subscribers not provisioned for SaaS, handling lost data associated with subscribers not provisioned for SaaS, and/or the like.

Some implementations described herein provide a device (e.g., a proxy UDM) that provides network-based provisioning of combined security services for subscribers. For example, the device may receive control traffic that includes a plurality of provisioning events associated with a network, and may identify provisioning events, of the plurality of provisioning events, that are associated with a service. The device may calculate a quantity of the provisioning events that are associated with the service, and may determine whether the quantity of the provisioning events satisfies a quantity threshold. The device may provide the quantity of the provisioning events to network devices that provide the service to subscribers based on the quantity of the provisioning events failing to satisfy the quantity threshold, or may calculate a remaining quantity of the provisioning events that are associated with the service based on the quantity of the provisioning events satisfying the quantity threshold. The device may cause another device to be added for the remaining quantity of the provisioning events, and may cause the other device to provide the remaining quantity of the provisioning events to the network devices that provide the service to the subscribers.

In this way, the proxy UDM provides network-based provisioning of combined security services for subscribers. For example, the proxy UDM may determine a quantity of provisioning events for subscribers of the combined security services from a UPF based on monitoring an interface (e.g., an S6b interface) between an authentication, authorization, and accounting (AAA) device and the UPF, an interface (e.g., an N8 interface) between an access and mobility management function (AMF) and a unified data repository (UDR), or an interface (e.g., an N10 interface) between a session management function (SMF) and a UDM. The proxy UDM may handle up to a quantity threshold of provisioning events. Once the quantity threshold of provisioning events is reached, the proxy UDM may cause another proxy UDM to be added to handle a next quantity threshold of provisioning events. Thus, the proxy UDM may conserve computing resources, networking resources, and/or other resources that would have otherwise been consumed by failing to provision combined security services for subscribers when the quantity of provisioning events exceeds the particular quantity, handling network threats associated with subscribers not provisioned for SaaS, handling lost data associated with subscribers not provisioned for SaaS, and/or the like.

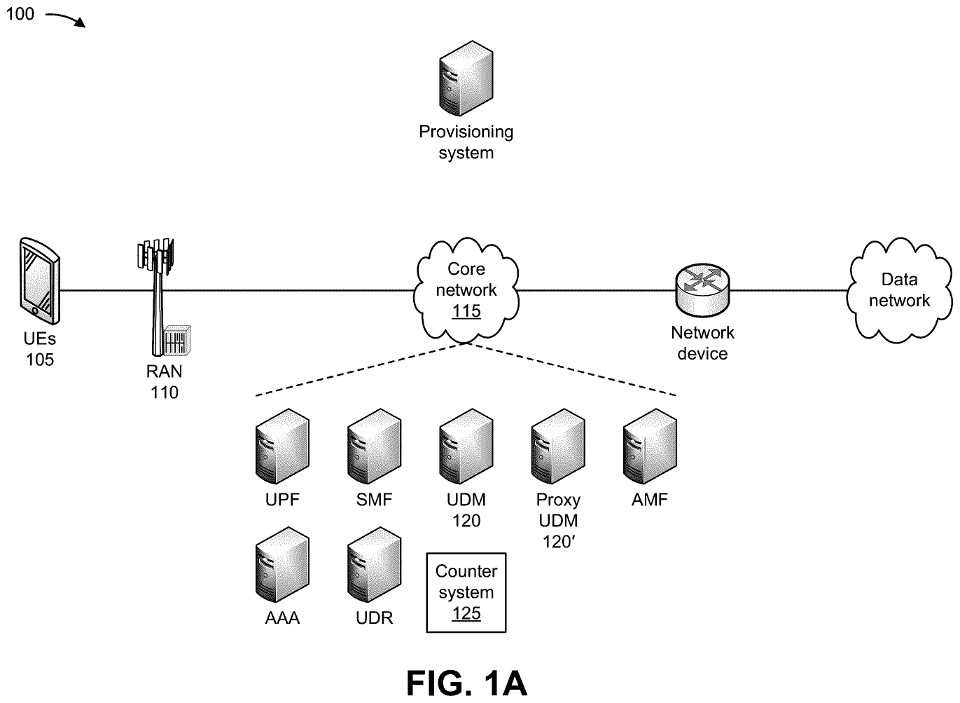

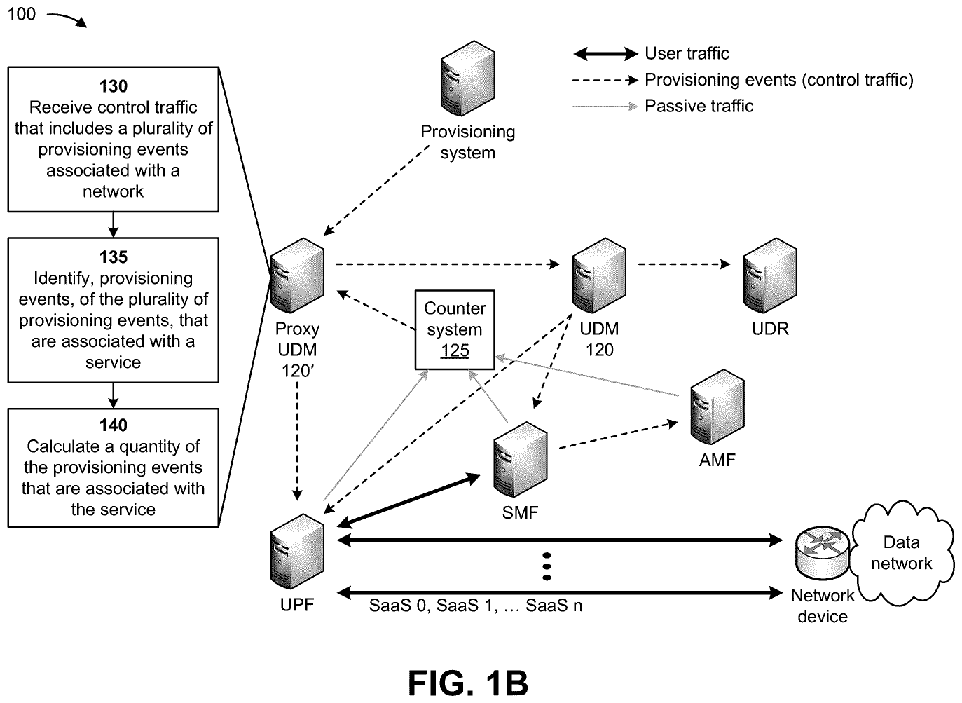

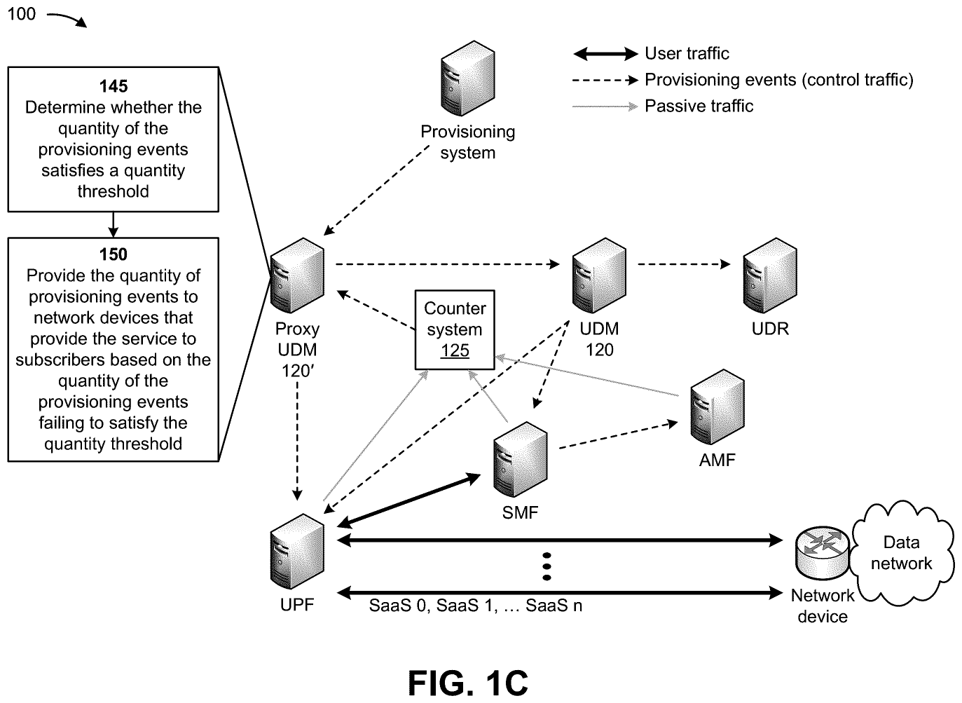

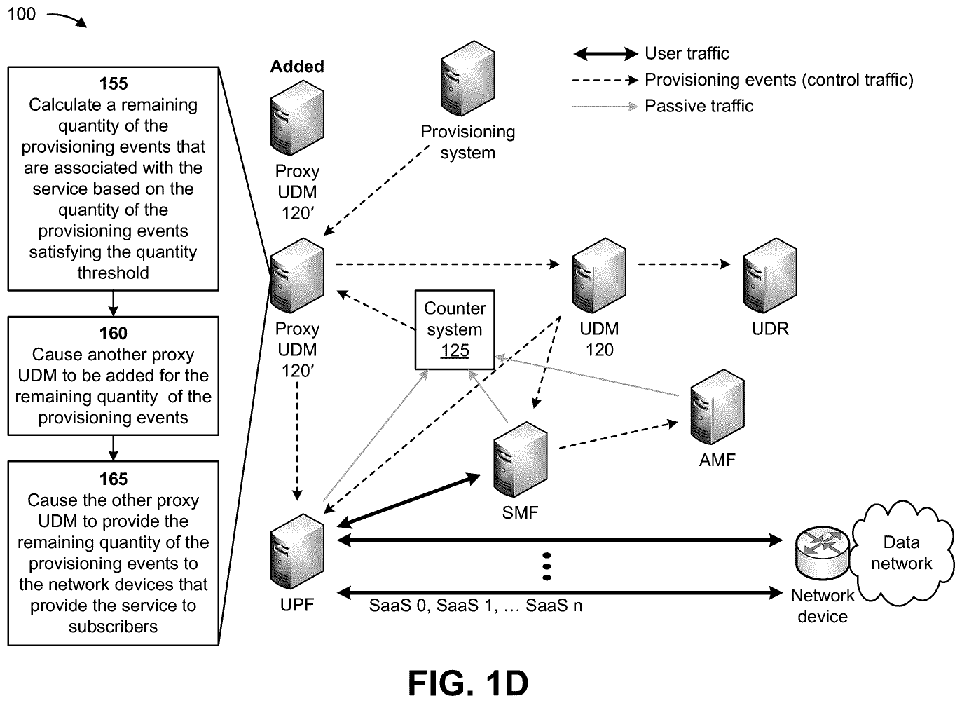

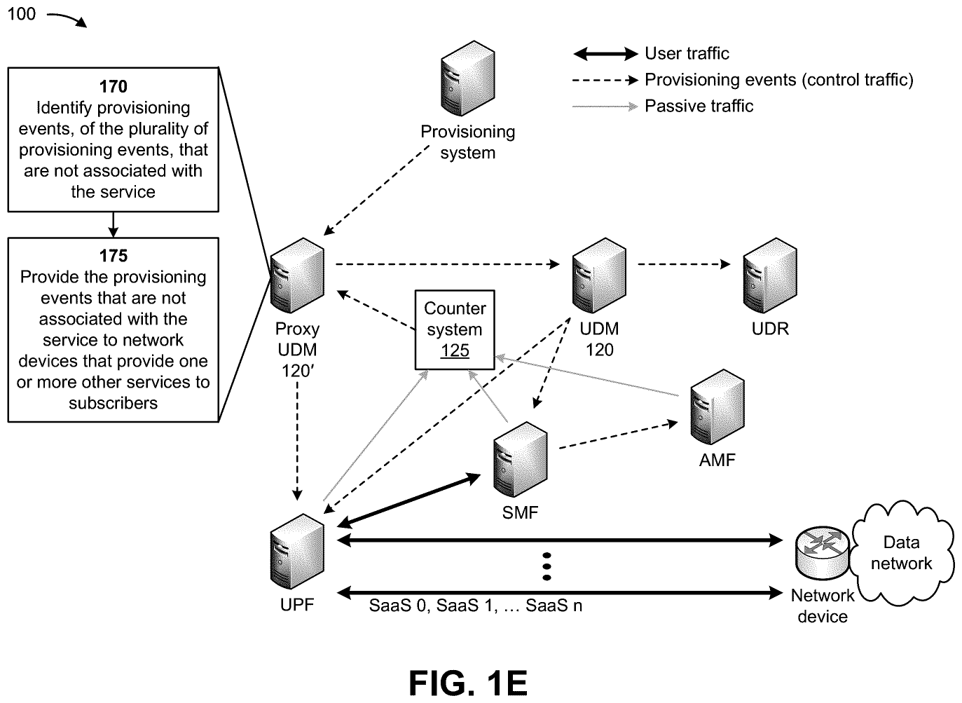

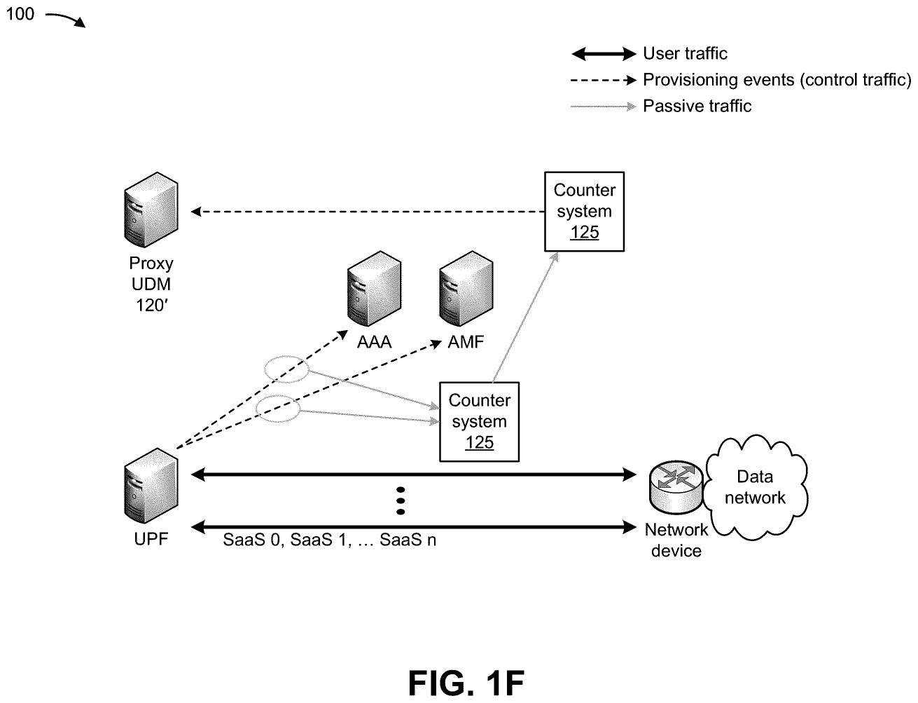

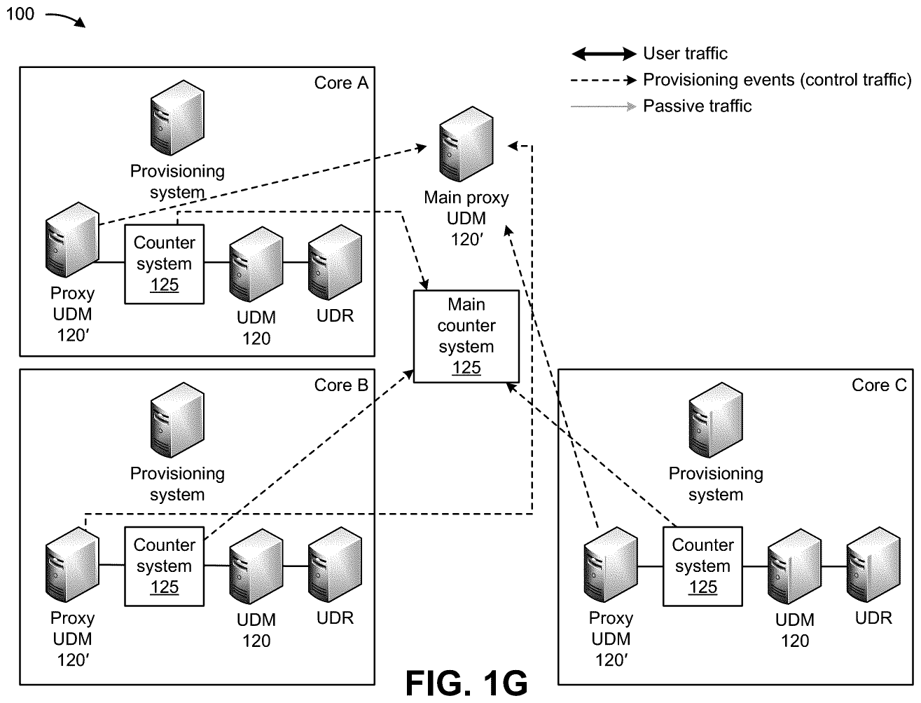

FIGS. 1A-1G are diagrams of an example 100 associated with network-based provisioning of combined security services for subscribers. As shown in FIGS. 1A-1G, the example 100 includes UEs 105, a radio access network (RAN) 110, and a core network 115 that includes a user plane function (UPF), a session management function (SMF), a unified data management (UDM) device 120, a proxy UDM 120′, an access and mobility management function (AMF), an authentication, authorization, and accounting (AAA) device, a unified data repository (UDR), and a counter system 125. As further shown, the example 100 includes a provisioning system, a network device, and a data network. Further details of the UEs 105, the RAN 110, the core network 115, the UPF, the SMF, the UDM 120, the proxy UDM 120′, the AMF, the AAA, the UDR, the counter system 125, the provisioning system, the network device, and the data network are provided elsewhere herein.

As shown in FIG. 1A, the UEs 105 may utilize the RAN 110 to communicate with the core network 115 and to further communicate with the data network, via the core network 115 and the network device. The provisioning system may provision the core network 115 and network elements for services, such as SaaS, a threat protection, a firewall service, and/or the like. The services may be provided to subscribers associated with the UEs 105. Although a single RAN 110, core network 115, proxy UDM 120′, counter system 125, provisioning system, and network device are depicted in FIG. 1A, in some implementations, more than one RAN 110, core network 115, proxy UDM 120′, counter system 125, provisioning system, and/or network device may be provided. Furthermore, although implementations are described in connection with a fifth generation (5G) core network, the implementations may be utilized with other types of core networks, such as a fourth generation (4G) core network.

As shown in FIG. 1B, the UPF of the core network 115 may process user traffic received from the UEs 105 and associated with the network device and the data network. In some implementations, the user traffic may be associated with one or more services provided by the core network 115 and/or the data network to the UEs 105. As further shown, the user traffic may also be exchanged between the UPF and the SMF.

As further shown in FIG. 1B, the provisioning system may generate control traffic that includes a plurality of provisioning events associated with provisioning network elements of the core network 115. The provisioning events may provision the network elements of the core network 115 for providing one or more services to the UEs 105, via the network device and the data network. The provisioning system may provide the control traffic to the proxy UDM 120′, and the proxy UDM 120′ may provide the control traffic to the UDM 120 and the UPF. The UDM 120 may provide the control traffic to the UDR, the UPF, and the SMF. The SMF may provide the control traffic to the AMF, and the counter system 125 may provide the control traffic to the proxy UDM 120′.

As further shown in FIG. 1B, the counter system 125 may receive passive traffic (e.g., identifying the plurality of provisioning events in the control traffic) from the UPF, the SMF, and AMF. In some implementations, the counter system 125 may receive the passive traffic from the UPF based on monitoring an S6b interface associated with the UPF, may receive the passive traffic from the AMF based on monitoring an N8 interface associated with the AMF, may receive passive traffic from the SMF based on monitoring an N10 interface associated with the SMF, and/or the like. In some implementations, the proxy UDM 120′ alone or a combination of the proxy UDM 120′ and the counter system 125 may perform the functions described herein. Alternatively, the counter system 125 alone may perform the functions described herein.

As further shown in FIG. 1B, and by reference number 130, the proxy UDM 120′ and/or the counter system 125 may receive control traffic that includes a plurality of provisioning events associated with a network. For example, the provisioning system may generate the control traffic that includes the plurality of provisioning events associated with the core network 115. The plurality of provisioning events may be associated with a service (e.g., a combined security service, such as a combination of SaaS, a threat protection service, and a firewall service), may be associated with one or more services other than the service, and/or the like. The provisioning system may provide the control traffic that includes the plurality of provisioning events to the proxy UDM 120′, and the proxy UDM 120′ may receive the control traffic that includes the plurality of provisioning events from the provisioning system.

In some implementations, the proxy UDM 120′ may provide the control traffic to the UDM 120 and the UPF. The UDM 120 may provide the control traffic to the UDR, the UPF, and the SMF. The SMF may provide the control traffic to the AMF. The counter system 125 may monitor the control traffic associated with the UPF, the SMF, and the AMF, and may provide the monitored control traffic to the proxy UDM 120′. In some implementations, the monitored control traffic and the control traffic received from the provisioning system may form the control traffic that includes the plurality of provisioning events.

As further shown in FIG. 1B, and by reference number 135, the proxy UDM 120′ and/or the counter system 125 may identify provisioning events, of the plurality of provisioning events, that are associated with a service. For example, the proxy UDM 120′ may identify provisioning events, of the plurality of provisioning events, that are associated with a service, such as the combined security service that includes the SaaS, the threat protection service, and the firewall service. In some implementations, when identifying the provisioning events, of the plurality of provisioning events, that are associated with the service, the proxy UDM 120′ may analyze the plurality of provisioning events for an identifier of the service (e.g., “SaaS”). The proxy UDM 120′ may identify the provisioning events, of the plurality of provisioning events, that are associated with the service based on analyzing the plurality of provisioning events for the identifier of the service. For example, the proxy UDM 120′ may determine that the plurality of provisioning events that include the identifier of the service are part of the provisioning events that are associated with the service.

As further shown in FIG. 1B, and by reference number 140, the proxy UDM 120′ and/or the counter system 125 may calculate a quantity of the provisioning events that are associated with the service. For example, since the proxy UDM 120′ may only handle a quantity threshold of provisioning events that are associated with the service, the proxy UDM 120′ may add up the provisioning events that are associated with the service to calculate the quantity of the provisioning events that are associated with the service. For example, the proxy UDM 120′ may determine that the quantity of the provisioning events that are associated with the service is about one hundred, one thousand, one thousand five hundred, and/or the like.

As shown in FIG. 1C, and by reference number 145, the proxy UDM 120′ and/or the counter system 125 may determine whether the quantity of the provisioning events satisfies a quantity threshold. For example, since the proxy UDM 120′ may only handle the quantity threshold of provisioning events that are associated with the service, the proxy UDM 120′ may determine whether the quantity of the provisioning events satisfies the quantity threshold. The quantity threshold may include a preconfigured quantity, such as about one thousand, one thousand five hundred, two thousand, and/or the like. In some implementations, when determining whether the quantity of the provisioning events satisfies the quantity threshold, the proxy UDM 120′ may determine that the quantity of the provisioning events fails to satisfy the quantity threshold based on the quantity of the provisioning events being less than or equal to the quantity threshold. For example, if the quantity is one thousand and the quantity threshold is one thousand five hundred, the proxy UDM 120′ may determine that the quantity of the provisioning events fails to satisfy the quantity threshold. Alternatively, when determining whether the quantity of the provisioning events satisfies the quantity threshold, the proxy UDM 120′ may determine that the quantity of the provisioning events satisfies the quantity threshold based on the quantity of the provisioning events being greater than the quantity threshold. For example, if the quantity is two thousand and the quantity threshold is one thousand five hundred, the proxy UDM 120′ may determine that the quantity of the provisioning events satisfies the quantity threshold. In some implementations, the quantity of the provisioning events that are associated with the service may be based on a quantity of subscribers to the service.

As further shown in FIG. 1C, and by reference number 150, the proxy UDM 120′ and/or the counter system 125 may provide the quantity of provisioning events to network devices that provide the service to subscribers based on the quantity of the provisioning events failing to satisfy the quantity threshold. For example, when the proxy UDM 120′ determines that the quantity of the provisioning events fails to satisfy the quantity threshold based on the quantity of the provisioning events being less than or equal to the quantity threshold, the proxy UDM 120′ may identify network devices that provide the service to subscribers. The proxy UDM 120′ may provide the quantity of provisioning events to the network devices that provide the service to subscribers or may cause the quantity of provisioning events to be provided to the network devices that provide the service to subscribers.

As shown in FIG. 1D, and by reference number 155, the proxy UDM 120′ and/or the counter system 125 may calculate a remaining quantity of the provisioning events that are associated with the service based on the quantity of the provisioning events satisfying the quantity threshold. For example, when the proxy UDM 120′ determines that the quantity of the provisioning events satisfies the quantity threshold based on the quantity of the provisioning events being greater than the quantity threshold, the proxy UDM 120′ may calculate the remaining quantity of the provisioning events that are associated with the service. In some implementations, the proxy UDM 120′ may calculate the remaining quantity of the provisioning events by subtracting the quantity threshold of the provisioning events that are associated with the service from a total quantity of the provisioning events that are associated with the service (e.g., where the total quantity is greater than the quantity threshold).

As further shown in FIG. 1D, and by reference number 160, the proxy UDM 120′ and/or the counter system 125 may cause another proxy UDM 120′ to be added for the remaining quantity of the provisioning events. For example, since the proxy UDM 120′ may only handle the quantity threshold of the provisioning events that are associated with the service, the proxy UDM 120′ may cause the core network to add (e.g., instantiate) another proxy UDM 120′ for handling the remaining quantity of the provisioning events. In some implementations, the proxy UDM 120′ may request that the provisioning system add the other proxy UDM 120′ for handling the remaining quantity of the provisioning events. The provisioning system may add the other proxy UDM 120′ for handling the remaining quantity of the provisioning events based on the request from the proxy UDM 120′.

As further shown in FIG. 1D, and by reference number 165, the proxy UDM 120′ and/or the counter system 125 may cause the other proxy UDM to provide the remaining quantity of the provisioning events to the network devices that provide the service to subscribers. For example, the proxy UDM 120′ may cause the provisioning system to provide the remaining quantity of the provisioning events to the other proxy UDM 120′ based on instructing or requesting that the provisioning system provide the remaining quantity of the provisioning events to the other proxy UDM 120′. The other proxy UDM 120′ may identify network devices that provide the service to subscribers and that are associated with the remaining quantity of the provisioning events. The other proxy UDM 120′ may provide the remaining quantity of provisioning events to the identified network devices that provide the service to subscribers or may cause the remaining quantity of provisioning events to be provided to the network devices that provide the service to subscribers.

As shown in FIG. 1E, and by reference number 170, the proxy UDM 120′ and/or the counter system 125 may identify provisioning events, of the plurality of provisioning events, that are not associated with the service. For example, the proxy UDM 120′ may identify provisioning events, of the plurality of provisioning events, that are not associated with the service (e.g., the combined security service). In some implementations, when identifying the provisioning events, of the plurality of provisioning events, that are not associated with the service, the proxy UDM 120′ may analyze the plurality of provisioning events for an identifier of the service (e.g., “SaaS”). The proxy UDM 120′ may identify the provisioning events, of the plurality of provisioning events, that are not associated with the service based on analyzing the plurality of provisioning events for the identifier of the service. For example, the proxy UDM 120′ may determine that the plurality of provisioning events that fail to include the identifier of the service are part of the provisioning events that are not associated with the service.

As further shown in FIG. 1E, and by reference number 175, the proxy UDM 120′ and/or the counter system 125 may provide the provisioning events that are not associated with the service to network devices that provide one or more other services to subscribers. For example, when the proxy UDM 120′ identifies the provisioning events, of the plurality of provisioning events, that are not associated with the service, the proxy UDM 120′ may identify network devices that provide one or more other services to subscribers. The proxy UDM 120′ may provide the provisioning events that are not associated with the service to the network devices that provide the one or more other services to subscribers or may cause the provisioning events that are not associated with the service to be provided to the network devices that provide the one or more other services to subscribers.

As shown in FIG. 1F, in some implementations, multiple counter systems 125 may be associated with the proxy UDM 120′. For example, a first counter system 125 may be associated with an interface between the UPF and the AAA and an interface between the UPF and the AMF. The first counter system 125 may monitor first control traffic associated with the interface between the UPF and the AAA, and may monitor second control traffic associated with the interface between the UPF and the AMF. The first counter system 125 may provide the first control traffic and the second control traffic to a second counter system 125. The second counter system 125 may combine the first control traffic and the second control traffic into combined control traffic, and may provide the combined control traffic to the proxy UDM 120′ for processing as described above.

As shown in FIG. 1G, in some implementations, a main proxy UDM 120′ and a main counter system 125 may be associated with three core networks 115 (e.g., core network A, core network B, and core network C). Each core network 115 may include a provisioning system, a proxy UDM 120′, a counter system 125, a UDM 120, and a UDR. As further shown, the main proxy UDM 120′ may receive control traffic from the proxy UDMs 120 provided in the core networks 115. The main counter system 125 may receive control traffic from the counter systems 125 provided in the core networks 115. The main proxy UDM 120′ may perform functions similar to the functions described above for the proxy UDM 120′ (e.g., in FIGS. 1A-1E). The main counter system 125 may perform functions similar to the functions described above for the counter system 125 (e.g., in FIGS. 1A-1E).

In this way, the proxy UDM 120′ provides network-based provisioning of combined security services for subscribers. For example, the proxy UDM 120′ may determine a quantity of provisioning events for subscribers of the combined security services from the UPF 240 based on monitoring an S6b interface between the AAA 250 and the UPF 240, an N8 interface between the AMF 230 and the UDR 245, or an N10 interface between the SMF 235 and the UDM 120. The proxy UDM 120′ may handle up to a quantity threshold of provisioning events. Once the quantity threshold of provisioning events is reached, the proxy UDM 120′ may cause another proxy UDM 120′ to be added to handle a next quantity threshold of provisioning events. Thus, the proxy UDM 120′ may conserve computing resources, networking resources, and/or other resources that would have otherwise been consumed by failing to provision combined security services for subscribers when the quantity of provisioning events exceeds the particular quantity, handling network threats associated with subscribers not provisioned for SaaS, handling lost data associated with subscribers not provisioned for SaaS, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

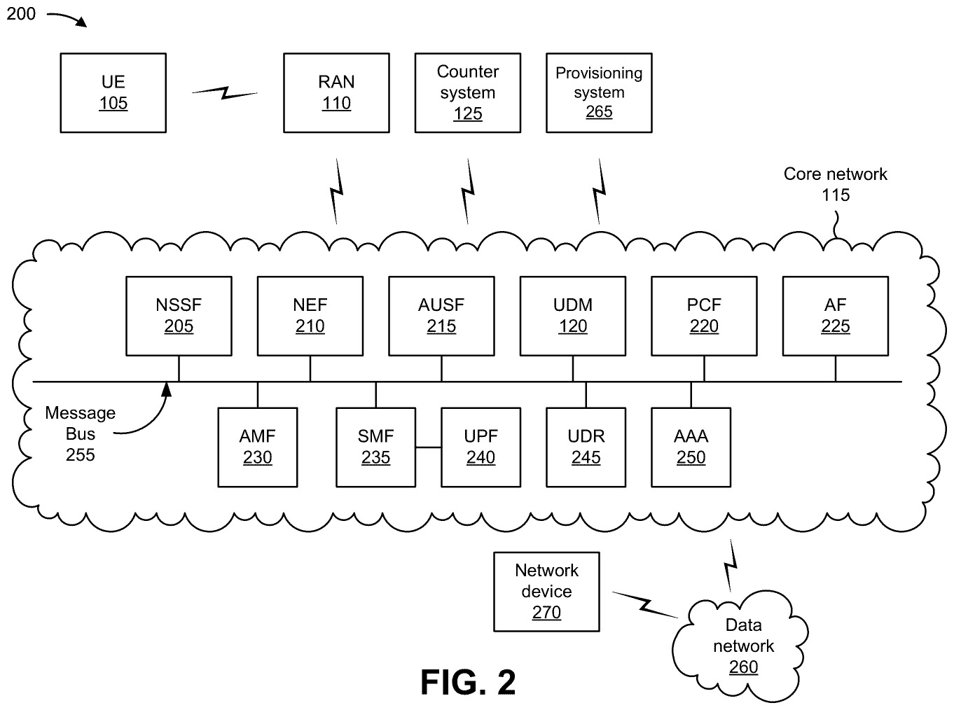

FIG. 2 is a diagram of an example environment 200 in which systems and/or methods described herein may be implemented. As shown in FIG. 2, the example environment 200 may include the UE 105, the RAN 110, the core network 115, the counter system 125, and a data network 260. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or the core network 115. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

The counter system 125 may include one or more devices capable of receiving, generating, storing, processing, providing, and/or routing information, as described elsewhere herein. The counter system 125 may include a communication device and/or a computing device. For example, the counter system 125 may include a server, such as an application server, a client server, a web server, a database server, a host server, a proxy server, a virtual server (e.g., executing on computing hardware), or a server in a cloud computing system. In some implementations, the counter system 125 may include computing hardware used in a cloud computing environment.

In some implementations, the core network 115 may include an example functional architecture in which systems and/or methods described herein may be implemented. For example, the core network 115 may include an example architecture of a 5G next generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, the UDM 120, a policy control function (PCF) 220, an application function (AF) 225, an AMF 230, an SMF 235, a UPF 240, a UDR 245, and/or an AAA 250. These functional elements may be communicatively connected via a message bus 255. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 120 includes one or more devices that store user data and profiles in the wireless telecommunications system. The UDM 120 may be used for fixed access and/or mobile access in the core network 115.

The PCF 220 includes one or more devices that provide a policy framework that incorporates network slicing, roaming, packet processing, and/or mobility management, among other examples.

The AF 225 includes one or more devices that support application influence on traffic routing, access to the NEF 210, and/or policy control, among other examples.

The AMF 230 includes one or more devices that act as a termination point for non-access stratum (NAS) signaling and/or mobility management, among other examples.

The SMF 235 includes one or more devices that support the establishment, modification, and release of communication sessions in the wireless telecommunications system. For example, the SMF 235 may configure traffic steering policies at the UPF 240 and/or may enforce user equipment Internet protocol (IP) address allocation and policies, among other examples.

The UPF 240 includes one or more devices that serve as an anchor point for intraRAT and/or interRAT mobility. The UPF 240 may apply rules to packets, such as rules pertaining to packet routing, traffic reporting, and/or handling user plane QoS, among other examples.

The UDR 245 includes one or more devices that provide a converged repository used by other network functions to store data. The UDR 245 may be implemented as cloud native function and may provide a unified database for storing application, subscription, authentication, service authorization, policy data, session binding, application state information, and/or the like.

The AAA 250 includes one or more devices that authenticates a device (e.g., a subscribing UE 105), checks whether the device is authorized to access a resource, and provides connection parameters, such as an IP address and quality of service (QOS) for data connectivity.

The message bus 255 represents a communication structure for communication among the functional elements. In other words, the message bus 255 may permit communication between two or more functional elements.

The data network 260 includes one or more wired and/or wireless data networks. For example, the data network 260 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third-party services network, an operator services network, and/or a combination of these or other types of networks.

The provisioning system 265 may include one or more devices capable of receiving, generating, storing, processing, providing, and/or routing information, as described elsewhere herein. The provisioning system 265 may include a communication device and/or a computing device. For example, the provisioning system 265 may include a server, such as an application server, a client server, a web server, a database server, a host server, a proxy server, a virtual server (e.g., executing on computing hardware), or a server in a cloud computing system. In some implementations, the provisioning system 265 may include computing hardware used in a cloud computing environment.

The network device 270 may include one or more devices capable of receiving, processing, storing, routing, and/or providing traffic (e.g., a packet and/or other information or metadata) in a manner described herein. For example, the network device 270 may include a router, such as a label switching router (LSR), a label edge router (LER), an ingress router, an egress router, a provider router (e.g., a provider edge router or a provider core router), a virtual router, or another type of router. Additionally, or alternatively, the network device 270 may include a gateway, a switch, a firewall, a hub, a bridge, a reverse proxy, a server (e.g., a proxy server, a cloud server, or a data center server), a load balancer, and/or a similar device. In some implementations, the network device 270 may be a physical device implemented within a housing, such as a chassis. In some implementations, the network device 270 may be a virtual device implemented by one or more computing devices of a cloud computing environment or a data center. In some implementations, a group of network devices 270 may be a group of data center nodes that are used to route traffic flow through a network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

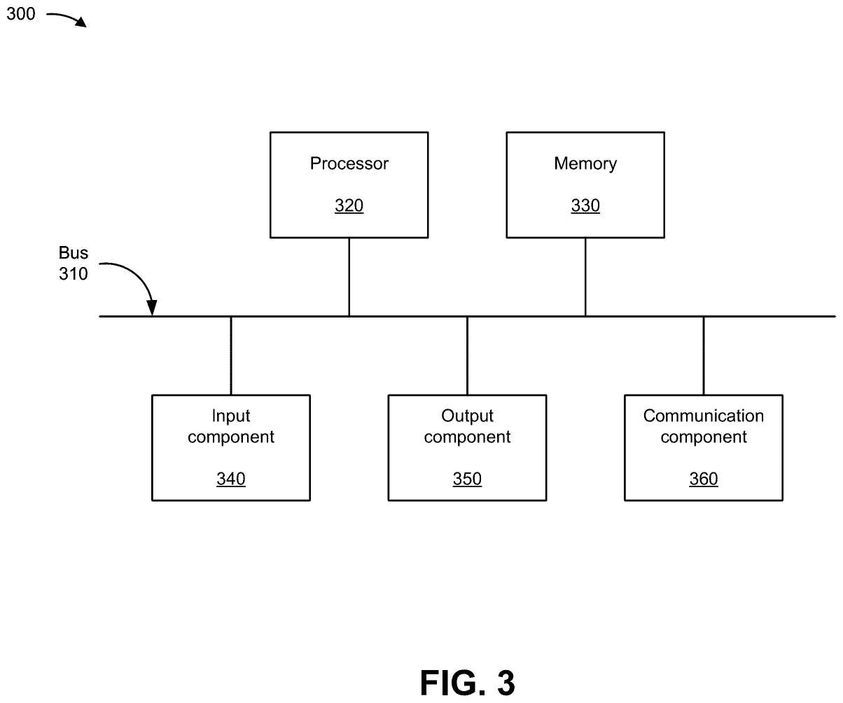

FIG. 3 is a diagram of example components of a device 300, which may correspond to the UE 105, the RAN 110, the proxy UDM 120′, the UDM the NSSF 205, the NEF 210, the AUSF 215, the PCF 220, the AF 225, the AMF 230, the SMF 235, the UPF 240, the UDR 245, the AAA 250, the provisioning system 265, and/or the network device 270. In some implementations, the UE 105, the RAN 110, the proxy UDM 120′, the UDM 120 the NSSF 205, the NEF 210, the AUSF 215, the PCF 220, the AF 225, the AMF 230, the SMF 235, the UPF 240, the UDR 245, the AAA 250, the provisioning system 265, and/or the network device 270 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

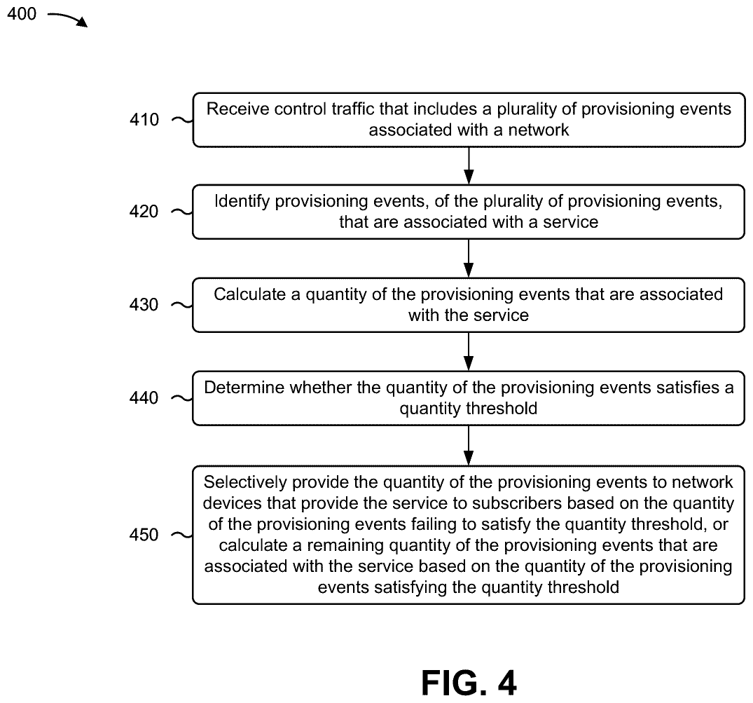

FIG. 4 is a flowchart of an example process 400 for network-based provisioning of combined security services for subscribers. In some implementations, one or more process blocks of FIG. 4 may be performed by a device (e.g., the proxy UDM 120′). In some implementations, one or more process blocks of FIG. 4 may be performed by another device or a group of devices separate from or including the device, such as a counter system (e.g., the counter system 125). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving control traffic that includes a plurality of provisioning events associated with a network (block 410). For example, the device may receive control traffic that includes a plurality of provisioning events associated with a network, as described above. In some implementations, receiving the control traffic that includes the plurality of provisioning events associated with the network includes receiving the control traffic that includes the plurality of provisioning events associated with the network from one or more interfaces provided between the network devices.

In some implementations, the device is one of a counter system, a proxy UDM device, or a combination of the counter system and the proxy UDM device. In some implementations, the control traffic that includes the plurality of provisioning events is generated by a provisioning system for the network. In some implementations, the network is a fourth generation core network or a fifth generation core network.

As further shown in FIG. 4, process 400 may include identifying provisioning events, of the plurality of provisioning events, that are associated with a service (block 420). For example, the device may identify provisioning events, of the plurality of provisioning events, that are associated with a service, as described above. In some implementations, the service is a combined security service that includes security as a service, a threat protection service, and a firewall service. In some implementations, identifying the provisioning events, of the plurality of provisioning events, that are associated with the service includes analyzing the plurality of provisioning events for an identifier of the service, and identifying the provisioning events, of the plurality of provisioning events, that are associated with the service based on analyzing the plurality of provisioning events for the identifier of the service.

As further shown in FIG. 4, process 400 may include calculating a quantity of the provisioning events that are associated with the service (block 430). For example, the device may calculate a quantity of the provisioning events that are associated with the service, as described above. In some implementations, the quantity of the provisioning events that are associated with the service is based on a quantity of subscribers to the service.

As further shown in FIG. 4, process 400 may include determining whether the quantity of the provisioning events satisfies a quantity threshold (block 440). For example, the device may determine whether the quantity of the provisioning events satisfies a quantity threshold, as described above. In some implementations, determining whether the quantity of the provisioning events satisfies the quantity threshold includes one of determining that the quantity of the provisioning events fails to satisfy the quantity threshold based on the quantity of the provisioning events being less than or equal to the quantity threshold, or determining that the quantity of the provisioning events satisfies the quantity threshold based on the quantity of the provisioning events being greater than the quantity threshold.

As further shown in FIG. 4, process 400 may include selectively providing the quantity of the provisioning events to network devices that provide the service to subscribers based on the quantity of the provisioning events failing to satisfy the quantity threshold, or calculating a remaining quantity of the provisioning events that are associated with the service based on the quantity of the provisioning events satisfying the quantity threshold (block 450). For example, the device may selectively provide the quantity of the provisioning events to network devices that provide the service to subscribers based on the quantity of the provisioning events failing to satisfy the quantity threshold, or may calculate a remaining quantity of the provisioning events that are associated with the service based on the quantity of the provisioning events satisfying the quantity threshold, as described above.

In some implementations, process 400 includes causing another device to be added for the remaining quantity of the provisioning events, and causing the other device to provide the remaining quantity of the provisioning events to the network devices that provide the service to the subscribers. In some implementations, the other device is a proxy UDM device of the network.

In some implementations, process 400 includes identifying provisioning events, of the plurality of provisioning events, that are not associated with the service, and providing the provisioning events that are not associated with the service to network devices that provide one or more other services to subscribers. In some implementations, identifying the provisioning events, of the plurality of provisioning events, that are not associated with the service includes analyzing the plurality of provisioning events for an identifier of the service, and identifying the provisioning events, of the plurality of the provisioning events, that are not associated with the service based on analyzing the plurality of provisioning events for the identifier of the service.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, control traffic that includes a plurality of provisioning events associated with a network;
identifying, by the device, provisioning events, of the plurality of provisioning events, that are associated with a service;
calculating, by the device, a quantity of the provisioning events that are associated with the service;
determining, by the device, whether the quantity of the provisioning events satisfies a quantity threshold; and
selectively:
providing, by the device, the quantity of the provisioning events to network devices that provide the service to subscribers based on the quantity of the provisioning events failing to satisfy the quantity threshold, or
calculating, by the device, a remaining quantity of the provisioning events that are associated with the service based on the quantity of the provisioning events satisfying the quantity threshold.

2. The method of claim 1, further comprising:
causing another device to be added for the remaining quantity of the provisioning events; and
causing the other device to provide the remaining quantity of the provisioning events to the network devices that provide the service to the subscribers.

3. The method of claim 2, wherein the other device is a proxy unified data management device of the network.

4. The method of claim 1, further comprising:
identifying provisioning events, of the plurality of provisioning events, that are not associated with the service; and
providing the provisioning events that are not associated with the service to network devices that provide one or more other services to subscribers.

5. The method of claim 4, wherein identifying the provisioning events, of the plurality of provisioning events, that are not associated with the service comprises:
analyzing the plurality of provisioning events for an identifier of the service; and
identifying the provisioning events, of the plurality of the provisioning events, that are not associated with the service based on analyzing the plurality of provisioning events for the identifier of the service.

6. The method of claim 1, wherein the service is a combined security service that includes security as a service, a threat protection service, and a firewall service.

7. The method of claim 1, wherein receiving the control traffic that includes the plurality of provisioning events associated with the network comprises:
receiving the control traffic that includes the plurality of provisioning events associated with the network from one or more interfaces provided between the network devices.

8. A device, comprising:
one or more processors configured to:
receive control traffic that includes a plurality of provisioning events associated with a network;
identify provisioning events, of the plurality of provisioning events, that are associated with a service;
calculate a quantity of the provisioning events that are associated with the service;
determine whether the quantity of the provisioning events satisfies a quantity threshold; and
provide the quantity of the provisioning events to network devices that provide the service to subscribers based on the quantity of the provisioning events failing to satisfy the quantity threshold.

9. The device of claim 8, wherein the one or more processors, to identify the provisioning events, of the plurality of provisioning events, that are associated with the service, are configured to:
analyze the plurality of provisioning events for an identifier of the service; and
identify the provisioning events, of the plurality of provisioning events, that are associated with the service based on analyzing the plurality of provisioning events for the identifier of the service.

10. The device of claim 8, wherein the device is one of a counter system, a proxy unified data management (UDM) device, or a combination of the counter system and the proxy UDM device.

11. The device of claim 8, wherein the control traffic that includes the plurality of provisioning events is generated by a provisioning system for the network.

12. The device of claim 8, wherein the network is a fourth generation core network or a fifth generation core network.

13. The device of claim 8, wherein the one or more processors, to determine whether the quantity of the provisioning events satisfies the quantity threshold, are configured to one of:
determine that the quantity of the provisioning events fails to satisfy the quantity threshold based on the quantity of the provisioning events being less than or equal to the quantity threshold; or
determine that the quantity of the provisioning events satisfies the quantity threshold based on the quantity of the provisioning events being greater than the quantity threshold.

14. The device of claim 8, wherein the quantity of the provisioning events that are associated with the service is based on a quantity of subscribers to the service.

15. A non-transitory computer-readable medium storing a set of instructions, the set of instructions comprising:
one or more instructions that, when executed by one or more processors of a device, cause the device to:
receive control traffic that includes a plurality of provisioning events associated with a network;
identify provisioning events, of the plurality of provisioning events, that are associated with a service;
calculate a quantity of the provisioning events that are associated with the service;
determine that the quantity of the provisioning events satisfies a quantity threshold;
provide the quantity threshold of the provisioning events that are associated with the service to network devices that provide the service to subscribers;
calculate a remaining quantity of the provisioning events that are associated with the service;
cause another device to be added for the remaining quantity of the provisioning events; and
cause the other device to provide the remaining quantity of the provisioning events to the network devices that provide the service to the subscribers.

16. The non-transitory computer-readable medium of claim 15, wherein the other device is a proxy unified data management device of the network.

17. The non-transitory computer-readable medium of claim 15, wherein the one or more instructions further cause the device to:
identify provisioning events, of the plurality of provisioning events, that are not associated with the service; and
provide the provisioning events that are not associated with the service to network devices that provide one or more other services to subscribers.

18. The non-transitory computer-readable medium of claim 15, wherein the service is a combined security service that includes security as a service, a threat protection service, and a firewall service.

19. The non-transitory computer-readable medium of claim 15, wherein the one or more instructions, that cause the device to receive the control traffic that includes the plurality of provisioning events associated with the network, cause the device to:
receive the control traffic that includes the plurality of provisioning events from one or more interfaces provided between the network devices.

20. The non-transitory computer-readable medium of claim 15, wherein the one or more instructions, that cause the device to identify the provisioning events, of the plurality of provisioning events, that are associated with the service, cause the device to:
analyze the plurality of provisioning events for an identifier of the service; and
identify the provisioning events, of the plurality of provisioning events, that are associated with the service based on analyzing the plurality of provisioning events for the identifier of the service.
